(19) United States
(12) Patent Application Publication
(10) Pub. No.: US 2025/0183755 A1
(43) Pub. Date: Jun. 5, 2025

(54) ENERGY STORAGE DEVICE

(71) Applicant: Sergey KONOVALOV, Nester (IL)

(72) Inventor: Sergey KONOVALOV, Nester (IL)

(21) Appl. No.: 18/901,052

(22) Filed: Sep. 30, 2024

(30) Foreign Application Priority Data
Dec. 2, 2023 (IL) 309026

(51) Int. Cl. H02K 7/02; F03G 3/08

(52) U.S. Cl. CPC H02K 7/025; F03G 3/083

(57) ABSTRACT

Disclosed is a device suitable for storing received electrical energy as rotational energy and, providing the stored energy as electrical energy on demand.

### RELATED APPLICATION

The present application gains priority from Israel Patent IL 309026 having a filing date of 2 Dec. 2023 and which was granted on 2 Jul. 2024. Israel Patent IL 309026 is hereby incorporated by reference in its entirety.

### FIELD AND BACKGROUND OF THE INVENTION

The invention, in some embodiments, relates to the field of energy storage and, more particularly but not exclusively, to a device suitable for storing received electrical energy as rotational energy and, providing the stored energy as electrical energy on demand.

A challenge in the use of electrical power is load balancing the electricity generated with the electricity needed at any moment. Excess electricity may be produced when there is insufficient demand, for example during regenerative braking, during daylight hours using solar panels or when there is a particularly brisk wind using windmills. In contrast, insufficient electricity may be available when it is needed, for example when an electrical vehicle accelerates, at night with solar panels or when there is insufficient wind.

Known electrical energy storage devices have various limitations and disadvantages.

It would be useful to have a device able to store received electrical energy and to provide the stored energy as electrical energy on demand

### SUMMARY OF THE INVENTION

Some embodiments of the invention relate to a device suitable for storing received electrical energy as rotational energy and, providing the stored energy as electrical energy on demand.

According to an aspect of some embodiments of the teachings herein, there is provided a device for storing received electrical energy as rotational energy and for providing the stored energy as electrical energy on demand, comprising:
a. a base;
b. a frame rotatably-attached to the base, allowing rotation of the frame around a frame spin axis directed in a first direction;
c. a gimbal rotatably-attached to the frame, allowing rotation of the gimbal around a gimbal spin axis that is perpendicular to the frame spin axis;
d. a rotor rotatably-attached to the gimbal, allowing rotation of the rotor around a rotor spin axis that is perpendicular to the gimbal spin axis;
   wherein the base, the frame, the gimbal and the rotor together constitute a gyroscope assembly;
   and wherein the rotor is configured as a rotor of a rotating electric machine with a functionally-associated with the field of a rotating electric machine,
   and the gimbal is configured as a stator of the rotating electric machine with a functionally-associated stator leads to transmit electricity to and from the gimbal, the stator leads comprising at least two rotary electric connectors: a two stator leads gimbal-frame rotary electric connectors, and a two stator leads frame-base rotary electric connectors.

In some embodiments, the device further comprises electrical circuitry functionally associated with the stator lead 1 and the stator lead 2, the electrical circuitry having at least three states:
i. a first state wherein the electrical machine functions as a motor, allowing electricity input to the electrical circuitry to increase the rate of rotation of the rotor, allowing electrical energy of the electricity to be stored as rotational energy of the rotor;
ii. a second state wherein no electricity passes through the stator lead 1 and the stator lead 2 so that the rotor can rotate without inductive braking by interaction with the stator; and
iii. a third state wherein the electrical machine functions as a generator, allowing controlled conversion of rotational energy of the rotor to electricity that can be output from the electrical circuitry.

In some embodiments, at least one of the rotary electric connectors comprises a slip ring.

In some embodiments, at least one of the rotary electric connectors comprises a rotary transformer.

In some embodiments, the rotor is the armature of the rotating electric machine and the stator is the field of the rotating electric machine.

In some embodiments, the rotor is the field of the rotating electric machine, and the stator is the armature of the rotating electric machine.

Aspects and embodiments of the invention are described in the description hereinbelow and in the appended claims and Figures.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIGS. 1A and 1B are schematic depictions of an exemplary embodiment of the device according to the teachings herein, FIG. 1A of mechanical portions of the device and FIG. 1B of some of the electrical circuitry of the device.

### DESCRIPTION OF SOME EMBODIMENTS OF THE INVENTION

The invention, in some embodiments thereof, relates to a device suitable for storing received electrical energy as rotational energy and, providing the stored energy as electrical energy on demand.

The principles, uses and implementations of the teachings herein may be better understood with reference to the accompanying description and figures. Upon perusal of the description and figures present herein, one skilled in the art is able to implement the invention without undue effort or experimentation. In the figures, like reference numerals refer to like parts throughout.

Before explaining at least one embodiment in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

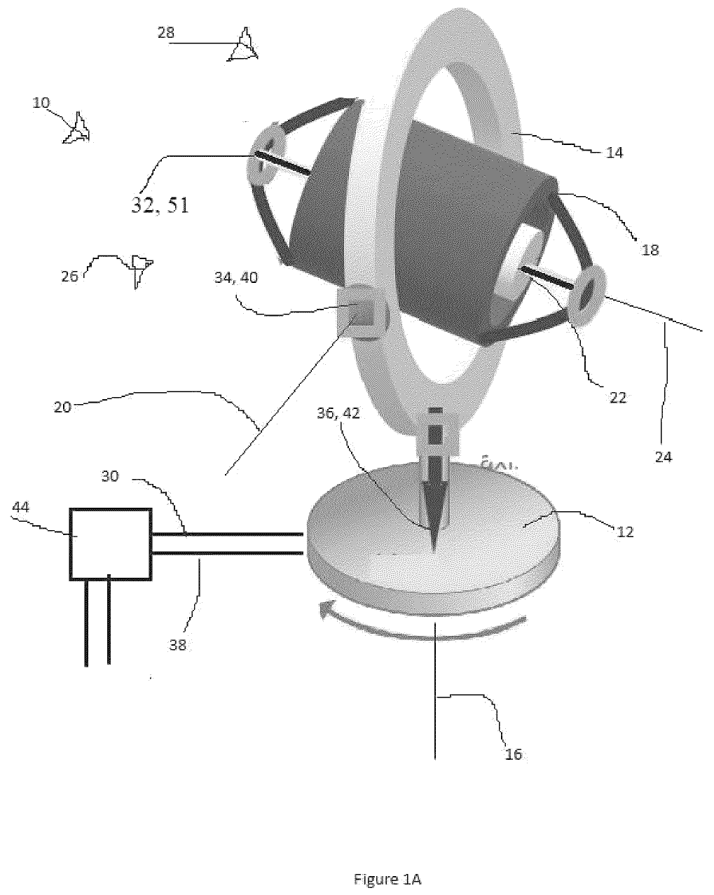

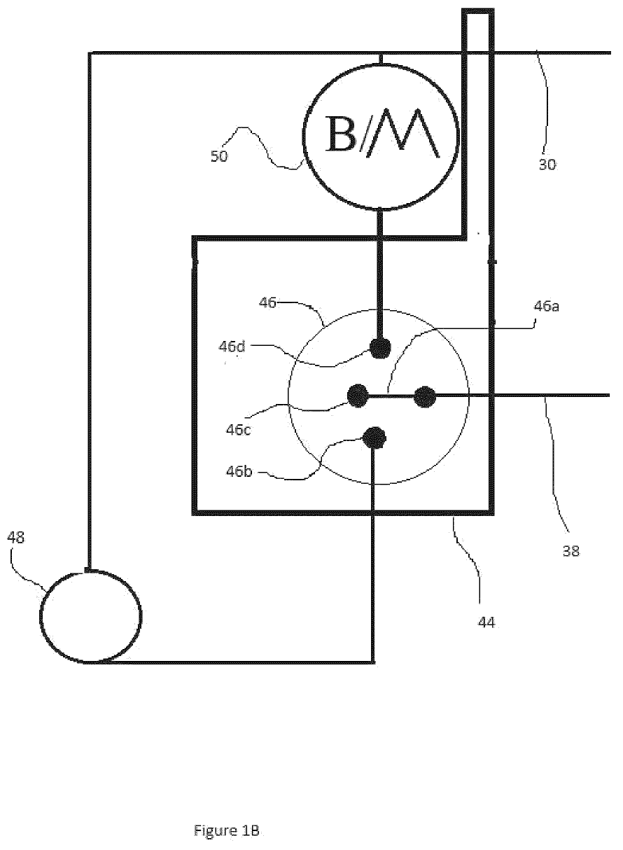

An exemplary embodiment of a device according to the teachings herein is schematically depicted in FIG. 1A (mechanical components of the device) and FIG. 1B (electrical circuitry of the device).

In FIG. 1A, a device 10 for storing received electrical energy as rotational energy and for providing the stored energy as electrical energy on demand according to the teachings herein, comprises:
a. a base 12;
b. a frame 14 rotatably-attached to base 12, allowing rotation of frame 14 around a frame spin axis 16 directed in a first direction;
c. a gimbal 18 rotatably-attached to frame 14, allowing rotation of gimbal 18 around a gimbal spin axis 20 that is perpendicular to frame spin axis 16;
d. a rotor 22 rotatably-attached to gimbal 18, allowing rotation of rotor 22 around a rotor spin axis 24 that is perpendicular to gimbal spin axis 20;
   wherein base 12, frame 14, gimbal 18 and rotor 22 together constitute a gyroscope assembly 26.

Specifically, the rotatable-attachment of the various components is through components such as low-friction bearings or similar so that gyroscope assembly 26 can function as a gyroscope as known to a person having ordinary skill in the art.

Further, gimbal 18 contains is configured as a stator of a rotating electric machine 28 with a functionally-associated stator winding lead 30 to transmit electricity to and from stator windings of the gimbal 18 is configured as a stator winding of the rotating electric machine 28 with a functionally-associated stator second winding lead 38 to transmit electricity to and from the stator winding gimbal 18.

In some embodiments, the rotor is the field of the rotating electric machine, and the stator is the armature winding of the rotating electric machine.

In some alternative embodiments, the rotor is the armature winding of the rotating electric machine and the stator is the field of the rotating electric machine.

Stator leads 30 and 38 each one comprises at least two rotary electric connectors. A first couple rotary electric connectors is stators leads frame-base rotary electric connectors 42 and 36. They provides electrical communication across the rotating joint between frame 14 and base 12. A second couple rotary electric connectors is a stator lead gimbal-frame rotary electric connectors 40 and 34 they provide electrical communication across the rotating joint between gimbal 18 and frame 14.

In some alternative embodiments where rotor is the armature winding leads 30 and 38 comprises at least three couple of rotary electric connectors. A first couple of rotary electric connectors is a rotor leads frame-base rotary electric connectors 36, 42. They provide electrical communication across the rotating joint between frame 14 and base 12. A second couple of rotary electric connector is a rotor leads gimbal-frame rotary electric connector 34, 40 that provide electrical communication across the rotating joint between gimbal 18 and frame 14. A third rotary electric connector is a rotor leads rotor-gimbal rotary electric connector 32, 51 They provides electrical communication across the rotating joint between rotor 22 and gimbal 18.

The various rotary electric connectors are any suitable rotary electric connector. In some embodiments, at least one rotary electrical connector of the device comprises a slip ring. In some embodiments, at least one rotary electrical connector of the device comprises a rotary transformer. In some embodiments, all of the rotary electric connectors are of the same type. Alternatively, in some embodiments at least one rotary electric connector is of a different type than at least one other rotary electrical connector.

Device 10 further comprises electrical circuitry 44. Details of electrical circuitry 44 are depicted in FIG. 1B. In FIG. 1B is seen that electrical circuitry 44 of device 10 comprises a three-way switch 46 having three positions.

When conductor 46a is in electrical communication with contact 46b, there is an electrical circuit between electrical machine 28 and power source 48 through stator lead 30 and stator lead 38. This is a first state of electrical circuitry 44 that allows electrical machine 28 to function as a motor. Specifically, electricity input from power source 48 to electrical circuitry 44 to increase the rate of rotation of rotor 22, thereby allowing electrical energy of the electricity from power source 48 to be stored as rotational energy of rotor 22.

When conductor 46a is in electrical communication with contact 46c (as depicted in FIG. 1B) electrical machine 28 is not part of an electrical circuit through stator lead 30 and stator lead 38. This is a second state of electrical circuitry 44 where no electricity passes through the stator lead 30 and the stator lead 38 so that rotor 22 can rotate without inductive braking by interaction with the stator of electrical machine 28.

When conductor 46a is in electrical communication with contact 46d, there is an electrical circuit between electrical machine 28 and a motor/battery 50 through stator lead 30 and stator lead 38. This is a third state of electrical circuitry 44 that allows electrical machine 28 to function as a generator, allowing controlled conversion of rotational energy of rotor 22 to electricity that can be output from the electrical circuitry 44 to operate motor or charge a battery 50.

Unless otherwise defined, all technical and scientific terms used herein have the same meaning as commonly understood by one of ordinary skill in the art to which the invention pertains. In case of conflict, the specification, including definitions, takes precedence.

As used herein, the terms “comprising”, “including”, “having” and grammatical variants thereof are to be taken as specifying the stated features, integers, steps or components but do not preclude the addition of one or more additional features, integers, steps, components or groups thereof. As used herein, the indefinite articles “a” and “an” mean “at least one” or “one or more” unless the context clearly dictates otherwise.

As used herein, when a numerical value is preceded by the term “about”, the term “about” is intended to indicate+/−10%. As used herein, a phrase in the form “A and/or B” means a selection from the group consisting of (A), (B) or (A and B). As used herein, a phrase in the form “at least one of A, B and C” means a selection from the group consisting of (A), (B), (C), (A and B), (A and C), (B and C) or (A and B and C).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Embodiments of methods and/or devices described herein may involve performing or completing selected tasks manually, automatically, or a combination thereof. Some methods and/or devices described herein are implemented with the use of components that comprise hardware, software, firmware or combinations thereof. In some embodiments, some components are general-purpose components such as general purpose computers, digital processors or oscilloscopes. In some embodiments, some components are dedicated or custom components such as circuits, integrated circuits or software.

For example, in some embodiments, some of an embodiment is implemented as a plurality of software instructions executed by a data processor, for example which is part of a general-purpose or custom computer. In some embodiments, the data processor or computer comprises volatile memory for storing instructions and/or data and/or a non-volatile storage, for example, a magnetic hard-disk and/or removable media, for storing instructions and/or data. In some embodiments, implementation includes a network connection. In some embodiments, implementation includes a user interface, generally comprising one or more of input devices (e.g., allowing input of commands and/or parameters) and output devices (e.g., allowing reporting parameters of operation and results.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A device for storing received electrical energy as rotational energy and for providing the stored energy as electrical energy on demand in electric vehicles without energy losing during driving, rotation, vibration and another intrusion, comprising:
a. a base of electric vehicle-chassis;
b. a frame rotatably-attached to said base, allowing rotation of said frame around a frame spin axis directed in a first direction;
c. a gimbal rotatably-attached to said frame, allowing rotation of said gimbal around a gimbal spin axis that is perpendicular to said frame spin axis;
d. a rotor rotatably-attached to said gimbal, allowing rotation of said rotor around a rotor spin axis that is perpendicular to said gimbal spin axis;
wherein said base, said frame, said gimbal and said rotor together constitute a gyroscope assembly that provides three-dimensional free spinning of the rotor as a field that eliminates losing energy mechanical friction;
and wherein
said rotor is configured as a rotor of a rotating electric machine functionally-
associated with the field of a rotating electric machine
and
said gimbal is configured as a stator of said rotating electric machine with a functionally-associated stator leads to transmit electricity to and from said gimbal, said stator leads comprising at least two rotary electric connectors:
a two stator leads gimbal-frame rotary electric connectors, and
a two stator leads frame-base rotary electric connectors.

2. The of claim 1, further comprising electrical circuitry functionally associated with said stator lead 1 and said stator lead 2, said electrical circuitry having at least three states:
i. a first state wherein said electrical machine functions as a motor, allowing electricity output to said electrical circuitry to increase the rate of rotation of said rotor, allowing electrical energy of said electricity to be stored as rotational energy of said rotor;
ii. a second state wherein no electricity passes through said stator lead 1 and said stator lead 2 so that said rotor can rotate without inductive braking by interaction with said stator; and
iii. a third state wherein said electrical machine functions as a generator, allowing controlled conversion of rotational energy of said rotor to electricity that can be output from said electrical circuitry.

3. The device of claim 1, wherein at least one of said rotary electric connectors comprises a slip ring that binds securely the stator coil to another electric devises.

4. The device of claim 1, wherein at least one of said rotary electric connectors comprises a rotary transformer.

5. The device of claim 1, wherein:
said rotor is the armature of said rotating electric machine and
said stator is the field of said rotating electric machine.

6. The device of claim 1, wherein:
said rotor is the field of said rotating electric machine, and
said stator is the armature of said rotating electric machine.
